(19) United States
(12) Patent Application Publication
(10) Pub. No.: US 2005/0164143 A1
(43) Pub. Date: Jul. 28, 2005

(54) Continuous pusher-type furnacing system for the production of high-quality uniform boron nitride

(76) Inventors: Cressie E. Holcombe, Knoxville, TN (US); Lloyd R. Chapman, Kingston, TN (US); Ronald L. Beatty, Knoxville, TN (US)

Correspondence Address: Joseph T. Guy, Ph.D.;Nexsen Pruet Adams Kleemeier, LLC, PO Drawer 10648, Greenville, SC, 29603-0648, US

(21) Appl. No.: 10/756,989

(22) Filed: Jan. 14, 2004

(51) Int. Cl. F27B 9/02

(52) U.S. Cl. 432/128

(57) ABSTRACT

A process for continuously manufacturing boron nitride utilizing a graphite capsule/vessel container for the reaction mixture and a pusher-type of high-temperature furnace. The process comprises the steps of: a) during the preheat step: pushing the graphite capsule/vessel through hot zones such that the reacting mixture is heated uniformly throughout its cross-sectional area and is held at or below 1000° C.: b) during the ultra-high-temperature heating step: pushing the graphite capsule/vessel through hot zones such that the reacting mixture is heated uniformly throughout its cross-sectional area and is held in the range of 1600 to 2200° C.

### TECHNICAL FIELD

This invention relates to the high-temperature processing/production of boron nitride using a continuous pusher-type furnace.

### BACKGROUND ART

The present invention is directed to boron nitride formed in a continuous pusher-type furnace to provide boron nitride of uniform consistency of crystallinity and purity. More particularly, the present invention is directed to formation of boron nitride using a pusher-type of high-temperature furnace and a specialized boron nitride reaction capsule/vessel.

Boron nitride is widely used in a variety of applications and products. Specifically, boron nitride powder is used in cosmetics, as a cubic boron nitride precursor, as an additive in high thermal conductivity plastic products, referred to as “thermal-fill” applications, as release agents for aluminum casting, etc.

Boron nitride is typically formed in a batch process involving the reaction of boric acid, borates, boron oxides or the like with ammonia gas or with nitrogen-containing compounds such as melamine, urea or dicyandiamides that yield ammonia during heating in nitrogen atmosphere.

These processes have been referred to in U.S. Pat. Nos. 4,562,050; 4,784,978; 4,749,556; 5,854,155. A filler, such as calcium phosphate, may be used, as well as additives such as carbon or boron to affect final purity of the boron nitride powder. However, these processes all involve heating to temperatures of around 1000° C. to produce a “turbostratic” boron nitride that typically then requires further heating to temperatures of 1600° C. to 2200° C. to obtain good crystallinity and reduce residual boron oxide.

As an example of typical processing, boric acid is normally blended with melamine in a ratio of 5 pounds of melamine to 7 pounds of boric acid. This is placed into the large graphite “pot” and heated from room temperature up to 1000° C. for approximately 2 hours residence time at the 1000° C. level, after which the temperature is increased to 1600-2200° C. for a residence time of 2 hours in that range. During the period of heating up to 1000° C. in the nitrogen atmosphere, gases evolve—mostly ammonia but also including water, carbon monoxide, carbon dioxide, hydrogen, hydrogen cyanide, boron oxide(s), and other species—leaving the “turbostratic” boron nitride with a considerable amount, in the range of 5 wt. % or more, of residual unreacted boron oxide. The heating up to the higher temperature range of 1600-2200° C. removes most of the remaining boron oxide by evaporation and also increases the crystallinity of the boron nitride while completing the reactions within incompletely-reacted boron nitride from 1000° C. that contains considerable oxygen within the crystal lattice and also has very varied stoichiometry and also includes some residual carbon from the reactant materials. In addition to increasing the crystallinity, the higher temperature heating causes growth of the individual crystallites. A final particle often occurs that is made of ultrafine crystallites of less than one-micrometer in size but connected together like a popcorn ball into larger particulates of five-to-ten micrometers and also weakly connected further into even larger balls of particles. The boron nitride production process is unusual in that the starting volume of reaction powder is essentially the same volume as what is found at the end of the process—although over 80 percent of the starting material is evolved as gaseous species during the process. The reaction container is essentially filled with extremely porous, and thus thermally insulating, reaction product boron nitride: this material is typically soft and greasy feeling when the crystallinity is high and is crunchy when the crystallinity is not high, such as when the highest temperatures have not been fully “felt” by the reaction mixture.

From the above description, the inherent limitations of the “pot” process can be envisioned. Within a large reaction “pot”, the powder mix is heated from the outside of the pot to the inside of the pot depending on the time it takes for the heat to “soak” into the reacting mixture. While the heat is being transmitted into the mixture, the mixture is becoming a porous “popcorn”-like material due to most of it being evolved as gases. The porous “popcorn” consisting of incompletely-reacted boron nitride in “turbostratic” form is quite insulating as it forms from the outside of the “pot” first: thus, the inside of the pot does not reach the temperatures that are seen on the outside of the “pot”—even with extremely long holding times. Since boron nitride production requires end-product within a reasonable overall timeframe, manufacturers must compromise the contents of the “pot” such that the outside of the “pot” is essentially of high crystallinity yet is often blended with the graphite from the “pot” that is dusted into the mix due to reaction with its evolving gases; the inside of the “pot” is often very poorly reacted and remains crunchy and poorly crystalline even after the highest temperature heating of 1900-2200° C.

Sometimes the poor reaction situation is addressed by having two separate heatings—the first one in a “pot” to 1000° C., after which the porous “popcorn” is removed and then lightly busted up and placed into another “pot” (or the same one) and reheated up to the 1900-2200° C. range for attaining the good crystallinity. The problem with this solution is that the chunks of porous “popcorn” after being busted up tend to pack much more tightly and thus keep much of the material that needs to evolve from doing so. Thus, the end product often is darkly colored gray or yellowish and contains carbon fragments and boron oxides and other species that do not evolve as well as if the process were done in a single step.

Whatever direction is used with the “pot” system, the end product consists of a central, poorly-reacted “core” material; a mid-reaction-area that is reasonably good product but still varies in crystallinity and purity due to the lack of uniformity of temperature and of evolution of the gases that should evolve from the “turbostratic” boron nitride in order for it to be of the best and highest quality; and an outer section/region next to the graphite of the “pot” which, although of high and good crystallinity, is generally mixed with graphite dust and visually looks bad.

The above process is the standard for the boron nitride industry and no solution for these problems has been possible. Attempts to reduce the size of the reaction pot result in poor overall boron nitride volume-of-material yields and generally poor end-purity due to increasing the contact area with the graphite container used for the reaction. The graphite “pot” is effectively “eaten up” on its surface with each run during the reaction to produce the boron nitride due to its reactions with the evolving gaseous species.

Manufacturers of boron nitride have opted to scoop out the regions of the “pot” into different grades of final product. The outside region is classed as refractory grade due to its color/visual-appearance. The innermost “core” of the reaction product of the “pot” is classed as run-of-the-mill, barely usable grade. The in-between region is considered the good boron nitride, although it too is still variable due to the temperature profile of the “pot.” Each of these grades is passed through a jet milling process in order to get the final material to a typical size of 1-10 micrometers: of course, this size is nominal, since each “particle” is not really such at all but is a conglomerate of ultrafine, submicron crystallites loosely bonded into a popcorn-like ball.

Manufacturers often subgrade the jet milled material into what is best for their final purpose, such as a “hot-pressing grade” or “thermal-fill” grade or some other grade that has a preferred range or size. This leads to considerable quantities of boron nitride powder that is “off-specification” for most uses: it often has odd particle distributions,—double- or triple-bell-shaped particle distribution curves or even truncated bell curves, where specific particle ranges have been extracted. Such oddball particle distributions and residuals have to be sold for economics of the process, leading to industry-wide problems with finding users of such strange particle size distributions.

There has been a long felt desire for a process for manufacturing boron nitride which is economical, reliable and which can be used to manufacture boron nitride of uniform consistency of crystallinity and purity.

The present invention provides a continuous pusher-type high-temperature furnacing process wherein boron nitride can be made with uniform consistency of crystallinity and purity.

### SUMMARY

It is an object of the present invention to provide an improved process for manufacturing boron nitride.

It is another object of the present invention to provide a continuous pusher-type, high-temperature furnacing process for manufacturing boron nitride whereby the boron nitride is uniform consistency of crystallinity and purity.

A particular feature of the present invention is the ability to manufacture boron nitride in a continuous fashion thereby eliminating the inefficiencies associated with batch manufacturing processes.

Another particular feature of the present invention is the ability to pre-select quality grades thereby eliminating the inefficiencies associated with manufacturing a broad range of grades wherein certain grades within the range are of minimal commercial value.

### BRIEF DESCRIPTION OF THE DRAWINGS

FIG. 1 illustrates a flow chart of the continuous process for manufacturing boron nitride.

FIG. 2 is schematic diagram of the manufacturing process for continuous manufacture of boron nitride.

FIG. 3 illustrates a preferred reaction vessel.

### DESCRIPTION OF THE PREFERRED EMBODIMENTS

Continuous boron nitride production is provided by processing intimately mixed powder reactants in a nitrogen atmosphere. The reactants are contained in the graphite capsule/vessel described further herein. The reaction capsule/vessel must be placed in a high temperature furnacing environment such that the contents are uniformly heated up from room temperature up to 1000° C. for approximately 2 hours residence time at the 1000° C. level, after which the temperature is increased to 1600-2200° C. for a residence time of 2 hours in that range, preferably in the range of 1900-2000° C.

The present invention will be described with reference to the figures which are an integral part of the present disclosure.

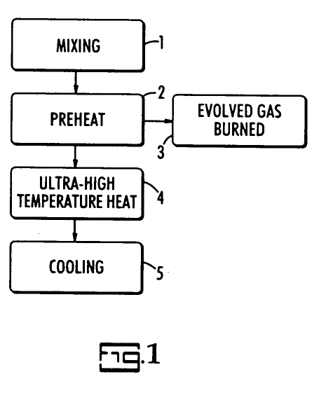

A flow chart for the continuous process of forming boron nitride is provided as FIG. 1. In FIG. 1, the boron reactant and nitrogen reactant are intimately mixed to form a precursor powder at 1. The boron reactant includes boric acid, borates, boron oxides or the like. Specifically preferred boron reactants are selected from boric acid, borates, boron oxides, orthoboric acid, metaboric acid, tetraboric acid, lithium borate, potassium borate, sodium perborate, boron trichloride and ammonium borate or like compounds containing boron. Boric acid is a preferred boron reactant. Nitrogen reactants include ammonia, ammonium chloride, melamine, urea, melam, melem, melon, dicyandiamide, ammelide, guanamines such as acetoguaname, and nitrogen containing salts such as guanidine hydrochloride, melamine hydrochloride, melamine phosphate or melamine oxalate or similar compounds generating ammonia on their dissociation. Melamine is most preferred.

As an example of typical processing, boric acid is normally blended with melamine in a ratio of 5 pounds of melamine to 7 pounds of boric acid. After this mixture is placed into the graphite capsule/vessel, it is “pushed” into the furnace and is subjected to a nitrogen atmosphere and heated in the preheat step at 2. During the preheat, the temperature is raised to approximately 1000° C. During preheat, the evolution of the gases is controlled by a counterflow of nitrogen directing the evolved gases toward the furnace entrance and up and out into an “afterburner” at which point the evolved gases are destroyed by combustion at 3 to minimize any environmental impact.

A preferred residence time of the graphite capsule/vessel of approximately 2 hours at the 1000° C. temperature allows the volatiles to escape. The residence time at 1000° C. and time of heating to 1000° C. can be varied within wide limits, as long as the amount of evolution from the graphite capsule/vessel results in an 80 percent weight loss of the contents. The push rate should be such that the graphite capsule/vessel is heated uniformly throughout its cross sectional area of 10 to 115 sq. inches. Thus, the push rate should be such that the graphite capsule/vessel is held at or below 1000° C. until 80% of the starting weight is volatilized. This ensures that there are no reactive gases/volatiles coming out at the higher temperatures that will rapidly deteriorate the graphite capsules/vessels.

After preheat, a porous “popcorn” consisting of incompletely-reacted boron nitride in “turbostratic” form results—occupying about the same volume as the initial powder reaction mixture, even though 80 wt. % of that mixture has evolved. After the preheat, this “turbostratic” boron nitride is subjected to ultra-high temperature heating at 4. The range of temperatures during ultra-high-temperature heating is from 1600 to 2200° C. It is preferred that the graphite capsule/vessel containing the “turbostratic” boron nitride be held in the temperature range of 1900 to 2000° C. for 1 to 2 hours. Thus, the push rate should be such that the graphite capsule/vessel is held in the temperature range until the crystallinity of the boron nitride is what is desired and until the boron oxide and other volatile impurities have been removed from the material. The temperature should be uniform over the cross-section of the graphite capsule/vessel and should be such that, typically, an additional 2% weight loss occurs based on the starting weight of material placed into the graphite capsule/vessel. Essentially, the final yield is about 18 wt. % of the starting weight utilized. By controlling the time the boron nitride material is exposed to the temperature range of 1600 to 2200° C., the resultant end-product can be controlled as to its crystallinity and purity. The graphite capsule/vessel ensures that the final resultant boron nitride will be of the desired uniform consistency of crystallinity and purity.

After ultra-high-temperature heating, the material is cooled at 5. The rate of cooling is not limiting.

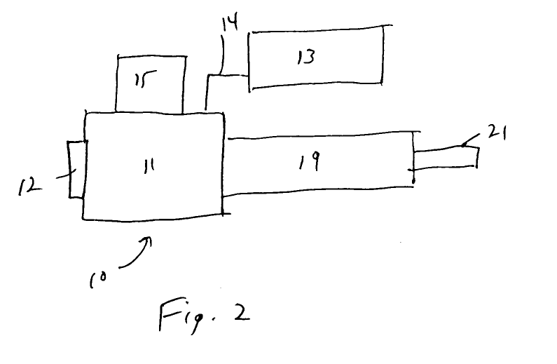

A schematic representation of the furnace assembly, 10, is provided in FIG. 2. In FIG. 2, the preheater, 11, comprises a sample receiving port, 12, wherein sample is introduced into the furnace assembly. The preheater, 11, is controlled, and reaction progress monitored, by a furnace control, 13, via communication link, 14. During preheat the evolution of gases such as ammonia, hydrogen cyanide, carbon monoxide, carbon dioxide, water, boron oxide(s) etc. are monitored and the rate of evolution controlled by the rate of pushing of the graphite capsule/vessel container. The furnace control, 13, continually monitors the gas.

The rate of throughput and application of heat to the graphite capsule/vessel allows the temperature to be uniform over the cross-sectional area of the reacting materials—thus giving a uniformly reacted final boron nitride product.

An afterburner, 15, combusts all gases exiting the preheater, 11. The “afterburner” may be of any design such that the combustible and noxious gases are effectively eliminated by the appropriate residence time and temperature in the afterburner.

After passing from the preheater, 11, the reaction mixture contained within the graphite capsule/vessel enters the ultra-high temperature heater, 19. The ultra-high temperature heater allows heating to the 1600 to 2200° C. range such that the graphite capsule/vessel is uniformly heated. A preferred temperature range is 1900 to 2000° C., and a preferred residence time in that range is two hours. The entire ultra-high-temperature heating generally removes 2 weight percent based on the starting material weight: or, the final product weighs around 18% as much as the starting material while occupying about 2/3 of the volume.

The final product passes from the ultra-high temperature heater into a cooling zone, 21. The cooling zone allows cooldown to room temperature. The rate of cooling is not material to the product. The final product should be of uniform, smooth “feel” with finger rubbing measured by placing a sample of the reaction product boron nitride between the fingers and rubbing it. Samples from anywhere within the cross-sectional area of the graphite capsule/vessel should have this uniform smooth “feel.” Such material should have a purity of over 95% boron nitride as well, and is generally over 99% purity. The degree of crystallinity is related to the degree of smoothness of “feel” during rubbing, as opposed to a rough, chalky “feel” for poorly crystalline material.

The graphite capsule/vessel is preferably passed through the furnace assembly by a force feed mechanism wherein as each graphite capsule/vessel container is introduced to the furnace assembly each previous graphite capsule/vessel container is moved one container length through the furnace.

The furnace control comprises a multiplicity of control modules and monitors in common or individual encasements that are standard for high-temperature processing systems. It would be apparent that computers or digital logical circuits can be employed as well known in the art.

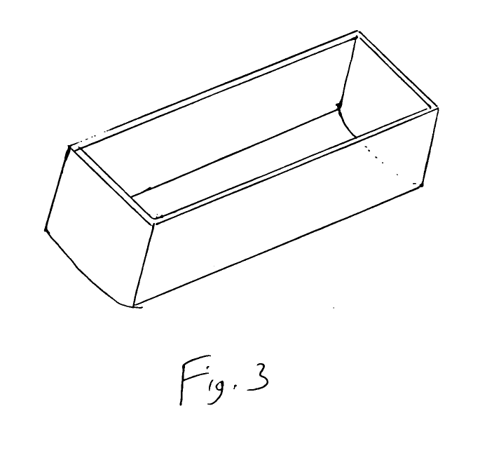

The preferred reaction capsule/vessel is illustrated in FIG. 3. The reaction capsule/vessel should be made of graphite and should have a cross-sectional area of 10 to 115 sq. inches and can be cylindrical in cross section, although other cross-sections are also usable—such as hexagonal, octagonal, square, rectangular, etc.

The ability to get the uniform crystallinity and purity depends on both the size of the capsule/vessel as well as its thickness and openness. The thickness of the graphite should not exceed 3/4 inch and not be thinner than 3/32 inch and preferably should be 1/4 to 5/16 inch in order to allow the thermal energy to uniformly get to the reaction mixture.

The reaction capsule/vessel can be vertical or horizontal in orientation. The vertical orientation may require batch processing and or specific chamber orientations in order to uniformly heat the reaction powders. Also, the height of a vertical chamber/vessel should not be more than 1.5 times the diameter (for a cylindrical vessel), or a similar relationship if some other cross-section than cylindrical is used. The opening of a vertical chamber needs to be 75 to 100% of the diameter of the chamber/vessel, such that the evolving gases will readily escape and not be trapped in the reacting mix which will lead to decreased final purity as well as rapid reaction and destruction of the graphite reaction chamber/vessel.

If the reaction capsule/vessel is horizontal in orientation, there is no length limitation other than that needed to ensure that the graphite capsule/vessel is heated evenly over its length. The top-region of the capsule/vessel should have an opening that is around one-half of the diameter in width and extending the majority of the length of the capsule/vessel. Another way of stating the size of the opening is that is should be about 50% of the longitudinal cross-sectional area of the capsule/vessel. Instead of one opening, a plurity of openings [i.e., several holes] can be used with the holes being 1/2 inch or larger in diameter and covering most of the top region of the capsule/vessel.

The above description is not meant to restrict the invention. Basically, there must be a large opening (or openings) in the capsule/vessel in order not to restrict the flow of exiting gaseous species from the boron nitride reaction mixture.

The reaction capsule vessel must be placed in a high temperature furnacing environment such that the contents are uniformly heated up from room temperature up to 1000° C. for approximately 2 hours residence time at the 1000° C. level, after which the temperature is increased to 1600-2200° C., and preferably in the range of 1900 to 2000° C., for a residence time of 2 hours in that range. The above-defined graphite capsule/vessel container will ensure that the contents will be uniformly heated throughout. The openings will ensure that the contents will form the “popcorn” material and be open enough to allow all the volatiles to get out of the way such that the final product is highly crystalline and uniform boron nitride from the center-to-the-outer region of the capsule/vessel.

The means to remove the gaseous evolution products such that they do not react with the furnace components is known to the art.

It is understood that a plurality of graphite capsule/vessels could be utilized—similar to the design of a revolver on a handgun, whereby each bullet-hole could be filled with a graphite capsule/vessel such that each one could be uniformly heated to yield the uniform boron nitride end product. It is also understood that an “ice cube tray” type of arrangement could be utilized, such that individual cubicles [or graphite capsule/vessels] could be combined and pushed into a furnacing environment: the individual graphite capsule/vessels would still be the method of producing the uniformity of reaction that is required for yielding the boron nitride in a uniform consistency of crystallinity and purity.

While a preferred embodiment has been shown and described, it will be understood that it is not intended to limit the disclosure, but rather it is intended to cover all modifications and alternate methods falling within the scope of the invention as defined in the appended claims.

1. A process for continuously manufacturing boron nitride utilizing a graphite capsule/vessel container for the reaction mixture and utilizing a pusher-type of high-temperature furnace and comprising the steps of
during the preheat step: pushing the graphite capsule/vessel through hot zones such that the reacting mixture is heated uniformly throughout its cross-sectional area and is held at or below 1000° C.
during the ultra-high-temperature heating step: pushing the graphite capsule/vessel through hot zones such that the reacting mixture is heated uniformly throughout its cross-sectional area and is held in the range of 1600 to 2200° C.

2. The process of claim 1 whereby, during the preheat step, the reacting mixture is held at or below 1000° C. until about 80 weight percent of the initial starting weight is volatilized.

3. The process of claim 1 whereby, during the ultra-high-temperature heating step, the reacting mixture is held in the range of 1600 to 2200° C. until 2 weight percent of the initial starting weight is volatilized.

4. The process of claim 1 whereby, during the ultra-high-temperature heating step, the temperature is held in the range of 1900 to 2000° C.

5. The process of claim 4 whereby the time in the temperature range is one to two hours.

6. The process of claim 1 further comprising a counterflow of nitrogen such that the offgassing products are directed towards the furnace entrance, up and out into an afterburner where the noxious gases are eliminated by time and temperature.

7. The process of claim 1 wherein said boron nitride is of uniform consistency of crystallinity and purity due to the uniformity of the temperature over its cross-sectional area during the preheat step and during the ultra-high-temperature step.

8. The process of claim 1 wherein said boron nitride has an overall purity of over 95% boron nitride and has a uniform smooth feel, when tested by finger rubbing, when the material is selected from anywhere within the cross sectional area of the graphite capsule/vessel container.
